(19) United States
(12) Patent Application Publication
(10) Pub. No.: US 2025/0055328 A1
(43) Pub. Date: Feb. 13, 2025

(54) LAMINATED IRON CORE AND METHOD FOR MANUFACTURING THE SAME

(71) Applicant: MITSUI HIGH-TEC, INC., Fukuoka (JP)

(72) Inventors: Hiroyuki MORIYAMA, Fukuoka (JP); Shintaro BABA, Fukuoka (JP); Hiroki KAKU, Fukuoka (JP)

(73) Assignee: MITSUI HIGH-TEC, INC., Fukuoka (JP)

(21) Appl. No.: 18/703,852

(22) PCT Filed: Oct. 21, 2022
(86) PCT No.: PCT/JP2022/039367

§ 371 Date: Apr. 23, 2024

(30) Foreign Application Priority Data
Oct. 25, 2021 (JP) 2021-173640

(51) Int. Cl. H02K 1/02; H02K 1/16; H02K 15/02

(52) U.S. Cl. CPC H02K 1/02; H02K 1/16; H02K 15/024

(57) ABSTRACT

Provided is a laminated iron core including: a laminate of electromagnetic steel sheets and a granular oxide that contains magnetite and covers a side surface of the laminate, in which a contact angle of a water droplet until 20 minutes elapses after dropping the water droplet on the side surface covered with the granular oxide is 80° or more. When heights of peaks detected in ranges of 2θ of 41° to 42° and 38° to 39° in XRD measurement of the side surface covered with the granular oxide are represented by H1 and H2, respectively, H1/(H1+H2) is 0.8 or more.

### TECHNICAL FIELD

The present disclosure relates to a laminated iron core and a method for manufacturing the same.

### BACKGROUND ART

In a bluing furnace, a technique of forming an oxide film on a surface of an iron-based laminated product is known. For example, PATENT LITERATURE 1 discloses a technique of forming an oxide film on an inner surface of a housing or an outer peripheral surface of a stator core by performing a bluing process in the atmosphere at 500° C. to 550° C.

PATENT LITERATURE 2 discloses a technique of forming an oxide film on an object to be processed by charging dry inert gas having a higher oxygen concentration than inert gas in a bluing furnace where the temperature gradually decreases from an inlet side toward an outlet side.

### CITATION LIST

### Patent Literature

Patent Literature 1: JP2015-42015A
Patent Literature 2: JPH07-42508A

### SUMMARY OF INVENTION

### Technical Problem

A laminated iron core is used in various environments. When the laminated iron core comes into contact with water and air (oxygen), red rust is formed in the laminated iron core. The formation of red rust in the laminated iron core is a factor for a decrease in performance of the laminated iron core. Accordingly, the present disclosure provides a laminated iron core where the formation of red rust can be prevented and a method for manufacturing the laminated iron core.

### Solution to Problem

A laminated iron core according to one aspect of the present disclosure includes: a laminate of electromagnetic steel sheets; and a granular oxide that contains magnetite and covers a side surface of the laminate, in which a contact angle of a water droplet until 20 minutes elapses after dropping the water droplet on the granular oxide covering the side surface is 80° or more.

The side surface of the laminate of the electromagnetic steel sheets in the laminated iron core is covered with the granular oxide containing magnetite. As such, since the side surface is covered with the granular oxide containing magnetite, the formation of red rust on the side surface can be prevented. Since the contact angle of the water droplet until 20 minutes elapses after dropping the water droplet on the granular oxide covering the side surface is 80° or more, the side surface has high water repellency. As such, since the side surface has high water repellency, infiltration of water into the gap between the electromagnetic steel sheets adjacent to each other in the laminating direction can be prevented. Therefore, the formation of red rust not only on the side surface of the laminated iron core but also in the laminated iron core can be prevented.

A laminated iron core according to another aspect of the present disclosure includes: a laminate of electromagnetic steel sheets; and a granular oxide that contains crystalline magnetite and covers a side surface of the laminate, in which when heights of peaks detected in ranges of 2θ of 41° to 42° and 38° to 39° in XRD measurement of the side surface covered with the granular oxide are represented by H1 and H2, respectively, H1/(H1+H2) is 0.8 or more.

The side surface of the laminate of the electromagnetic steel sheets in the laminated iron core is covered with the granular oxide containing crystalline magnetite. As such, since the side surface is covered with the granular oxide containing crystalline magnetite, the formation of red rust on the side surface can be prevented. In the XRD measurement of the side surface covered with the granular oxide, H1/(H1+H2) is 0.8 or more. Here, peaks detected in the range of 2θ of 41° to 42° include diffraction peaks derived from crystalline magnetite and crystalline hematite, respectively. On the other hand, peaks detected in the range of 2θ of 38° to 39° include a diffraction peak derived from crystalline hematite but do not include a diffraction peak derived from crystalline magnetite. Therefore, when H1/(H1+H2) is 0.8 or more, the ratio of crystalline magnetite to crystalline hematite in the granular oxide is sufficiently high. As such, the side surface covered with the oxide where the ratio of crystalline magnetite is sufficiently high has high water repellency. Accordingly, the infiltration of water into a gap between the electromagnetic steel sheets adjacent to each other in the laminating direction can be prevented. Therefore, the formation of red rust not only on the side surface of the laminated iron core but also in the laminated iron core can be prevented.

A method for manufacturing a laminated iron core according to still another aspect of the present disclosure includes oxidizing a side surface of a laminate of electromagnetic steel sheets by heating the laminate while introducing water vapor in a bluing furnace having an atmosphere containing oxygen. In the bluing furnace, a granular oxide containing magnetite is formed on the side surface of the laminate by heating the laminate under conditions including an oxygen concentration of less than 500 ppm and a heating temperature of 400° C. to 600° C.

According to the manufacturing method, the side surface of the laminate of the electromagnetic steel sheets can be covered with the oxide where the ratio of magnetite is high. Accordingly, the formation of red rust on the side surface can be prevented. The side surface covered with the oxide where the ratio of magnetite is sufficiently high has high water repellency. Accordingly, the infiltration of water into a gap between the electromagnetic steel sheets adjacent to each other in the laminating direction can be prevented. Therefore, the formation of red rust not only on the side surface of the laminated iron core but also in the laminated iron core can be prevented.

### Advantageous Effects of Invention

It is possible to provide a laminated iron core where the formation of red rust can be prevented and a method for manufacturing the laminated iron core.

### BRIEF DESCRIPTION OF DRAWINGS

FIG. 1 is a perspective view illustrating an example of a laminated iron core.

FIG. 2 is a cross-sectional view schematically illustrating a cross-sectional structure of a laminated iron core taken along a laminating direction.

FIG. 3 is a diagram schematically illustrating a contact angle of a water droplet dropped on a side surface of a laminate.

FIG. 4A is a diagram illustrating an example of an XRD measurement result of the side surface covered with a granular oxide.

FIG. 4B is a diagram illustrating an example of the XRD measurement result of the side surface covered with the granular oxide.

FIG. 5 is a diagram illustrating an example of a method for manufacturing the laminated iron core.

FIG. 6 is a diagram illustrating temporal changes of contact angles y of water droplets of Examples 1 to 4.

FIG. 7 is a diagram illustrating temporal changes of contact angles y of water droplets of Examples 5 and 6 and Comparative Examples 1 to 3.

FIG. 8 is a diagram illustrating temporal changes of contact angles y of water droplets of Examples 7 and 8.

FIG. 9 illustrates photographs of side surfaces of laminates in laminated iron cores according to Examples 2 to 6.

FIG. 10 illustrates photographs of side surfaces and cross-sections of laminates in laminated iron cores according to Examples 2, 3, and 4.

FIG. 11 illustrates photographs of side surfaces and cross-sections of laminates in laminated iron cores according to Examples 5 and 7.

FIG. 12 illustrates photographs of side surfaces and cross-sections of laminates in laminated iron cores according to Comparative Examples 1 and 2.

### DESCRIPTION OF EMBODIMENTS

Hereinafter, an embodiment of the present disclosure will be described with reference to the drawings depending on circumstances. Note that the following embodiment is an example for describing the present disclosure, and the present disclosure is not limited to the following content. In the description, the same reference numerals are used for the same elements or elements having the same functions, and the description thereof will not be repeated. Unless specified otherwise, a positional relationship such as up, down, left, and right are based on a positional relationship illustrated in the drawings. A dimensional ratio between elements is not limited to a ratio illustrated in the drawings.

A laminated iron core according to one embodiment includes: a laminate of electromagnetic steel sheets; and a granular oxide that contains magnetite and covers a side surface of the laminate. A contact angle y of a water droplet until 20 minutes elapses after dropping the water droplet on the side surface covered with the granular oxide is 80° or more. To improve water repellency, the contact angle y until 20 minutes elapses after dropping the water droplet may be 100° or more. The upper limit of the contact angle y until 20 minutes elapses after dropping the water droplet may be, for example, 140°. That is, an example of the contact angle y of the water droplet until 20 minutes elapses after dropping the water droplet is 80° to 140°. The contact angle y can be adjusted by changing conditions of a bluing step. For example, by increasing a heating time while controlling an oxygen concentration in a predetermined range or by increasing a heating temperature, the contact angle y can be increased. By increasing the water repellency as described above, infiltration of water into a gap between the electromagnetic steel sheets adjacent to each other in a laminating direction of the laminate can be prevented. As a result, the formation of red rust in the laminated iron core can be prevented.

To improve the water repellency, the contact angle y of a water droplet until 40 minutes elapses after dropping the water droplet on the side surface of the laminate covered with the granular oxide may be 80° or more or may be 85° or more. The upper limit of the contact angle y of the water droplet until 40 minutes elapses after dropping the water droplet on the side surface of the laminate may be, for example, 140°. That is, an example of the contact angle y of the water droplet until 40 minutes elapses after dropping the water droplet is 80° to 140°.

At least a part of the magnetite may be crystalline. As a result, the water repellency can be improved, and the formation of red rust in the laminated iron core can be prevented. The entirety of the magnetite in the oxide may be crystalline, or the magnetite in the oxide may include both crystalline magnetite and amorphous magnetite.

When heights of peaks detected in ranges of 2θ of 41° to 42° and 38° to 39° in XRD measurement of the side surface of the laminate covered with the granular oxide are represented by H1 and H2, respectively, H1/(H1+H2) may be 0.8 or more. In the range of 2θ of 41° to 42°, the highest diffraction peak of the crystalline magnetite (Fe₃O₄) and the second highest diffraction peak among diffraction peaks of hematite (Fe₂O₃) are detected. On the other hand, in the range of 2θ of 38° to 39°, the highest diffraction peak among diffraction peaks of crystalline hematite is detected. Accordingly, as the value of H1/(H1+H2) increases, a ratio of magnetite to the total amount of crystalline hematite and crystalline magnetite increases. As such, the side surface covered with the oxide where the ratio of crystalline magnetite is sufficiently high has high water repellency. By increasing the water repellency, infiltration of water into a gap between the electromagnetic steel sheets adjacent to each other in a laminating direction of the laminate can be prevented.

To improve the water repellency, H1/(H1+H2) may be 0.9 or more, may be 0.95 or more, or may be 0.98 or more. The value of H1/(H1+H2) can be adjusted by changing conditions of a bluing step. For example, by increasing the heating time, by increasing the heating temperature, or by increasing a dew point, the value of H1/(H1+H2) can be increased. In the X-ray diffraction (XRD) measurement in the present specification, a commercially available X-ray diffractometer (for example, D8 DISCOVER (device name) manufactured by Bruker Corporation) using a CuKα ray can be used.

A laminated iron core according to another embodiment includes a laminate of electromagnetic steel sheets; and a granular oxide that contains crystalline magnetite and covers a side surface of the laminate, in which when heights of peaks detected in ranges of 2θ of 41° to 42° and 38° to 39° in XRD measurement of the side surface covered with the granular oxide are represented by H1 and H2, respectively, H1/(H1+H2) is 0.8 or more. The side surface of the laminate is covered with the granular oxide where a ratio of magnetite to the total amount of crystalline hematite and crystalline magnetite is high. The side surface of the laminate has high water repellency. By having high water repellency, infiltration of water into a gap between the electromagnetic steel sheets adjacent to each other in a laminating direction of the laminate can be prevented. Accordingly, the formation of red rust in the electromagnetic steel sheets can be prevented.

In each of the embodiments, the granular oxide that covers the side surface of the laminate may include particles having a particle size of 0.3 μm or more. The oxide particles have high crystallinity such that the water repellency of the side surface can be further improved. To improve the water repellency, the particle size may be 0.4 μm or more or may be 0.5 μm or more. The upper limit of the particle size may be 3 μm or may be 2 μm to improve a bond strength to the side surface. The particle size of one oxide particle can be measured as the distance between two most distant points on an outer edge of the particle in an enlarged SEM image illustrating the side surface of the laminate.

In each of the embodiments, the side surface of the laminate may be covered with an oxide film containing the granular oxide. As a result, the formation of red rust on the side surface of the laminate and in the laminate can be further prevented. The thickness of the oxide film containing the granular oxide may be 0.1 μm to 2 μm. This thickness can be measured by imaging a cross-section of the laminate taken along the laminating direction with a scanning electron microscope (SEM) and measuring the length in a direction orthogonal to the side surface in the obtained SEM photograph. The lower limit of the thickness of the oxide film may be 0.1 μm, may be 0.2 μm, or may be 0.3 μm. As a result, corrosion resistance of the side surface of the laminate can be improved. On the other hand, the upper limit of the thickness of the oxide film may be 2 μm or may be I um. As a result, peeling of the oxide film can be prevented. To prevent the peeling of the oxide film, it is preferable that the oxide film does not have cavities.

In each of the embodiments, the granular oxide that covers the side surface of the laminate does not need to contain crystalline hematite. As a result, the water repellency of the side surface of the laminate can be improved. Whether hematite is present can be determined depending on whether a diffraction peak is present in the above-described XRD measurement. The granular oxide may be granular iron oxide. The granular oxide that covers the side surface of the laminate does not need to contain crystalline and amorphous hematite. That is, the granular oxide does not need to contain hematite at all.

In each of the embodiments, the electromagnetic steel sheets configuring the laminate may include stamped steel sheets. On side surfaces of the stamped steel sheets, the atomic arrangement is disordered by shearing. Therefore, the granular oxide can be smoothly formed on the side surface of the laminate by a bluing process. Accordingly, the corrosion resistance of the laminated iron core can be improved.

In each of the embodiments, the stamped steel sheets may be fastened to each other by swaging. A gap is more likely to be formed between a pair of stamped steel sheets fastened to each other by swaging as compared to a pair of stamped steel sheets bonded to each other using an adhesive. Therefore, water is likely to infiltrate, and red rust is likely to be formed in the laminate. In the present embodiment, the water repellency of the side surface of the laminate is high. Therefore, even when the stamped steel sheets are fastened to each other by swaging, the infiltration of water can be reduced, and the formation of red rust in the laminate can be prevented.

A method for manufacturing a laminated iron core according to one embodiment includes oxidizing a side surface of a laminate of electromagnetic steel sheets by heating the laminate while introducing water vapor in a bluing furnace having an atmosphere containing oxygen, in which in the bluing furnace, a granular oxide containing magnetite is formed on the side surface of the laminate by heating the laminate under conditions (bluing process conditions) including an oxygen concentration of less than 500 ppm, a heating temperature of 400° C. to 600° C., and a heating time at the heating temperature of 10 minutes or longer.

To promote the formation of crystalline magnetite and to prevent the formation of hematite, the oxygen concentration in the bluing process conditions may be 200 ppm or less. may be 50 ppm or less, or may be 30 ppm or less. The oxygen concentration in the present specification is a volume concentration in a standard state (temperature: 298.15 K, pressure: 105 Pa) measured by a commercially available oxygen meter. The lower limit of the oxygen concentration in the bluing process conditions may be 5 ppm to promote the formation of granular oxide.

To promote the formation of crystalline magnetite and to reduce damage to an insulating film provided on the surface of the laminate, the upper limit of the heating temperature in the bluing process conditions may be 580° C. To reduce the time of the bluing step, the lower limit of the heating temperature in the bluing process conditions may be 450° C. or may be 500° C.

To reduce damage to an insulating film provided on the surface of the laminate and to reduce the time of the bluing step, the heating time at the heating temperature may be 10 hours or shorter or may be 5 hours or shorter. To promote the formation crystalline magnetite, the heating time at the heating temperature may be 30 minutes or longer or may be 1 hour or longer.

The dew point of the bluing furnace (bluing process conditions) may be 10° C. or higher. The dew point can be adjusted by changing the flow rate of the water vapor introduced into the bluing furnace. By adding the water vapor to increase the dew point, the formation of the oxide (oxide film) on the side surface of the laminate can be promoted to prevent the formation of red rust on the side surface. To promote the formation of the oxide (oxide film) on the side surface of the laminate in the laminated iron core to prevent the formation of red rust, the dew point may be 20° C. or higher or may be 40° C. or higher. Due to the same reason, the upper limit of the dew point may be 100° C. or may be 80° C.

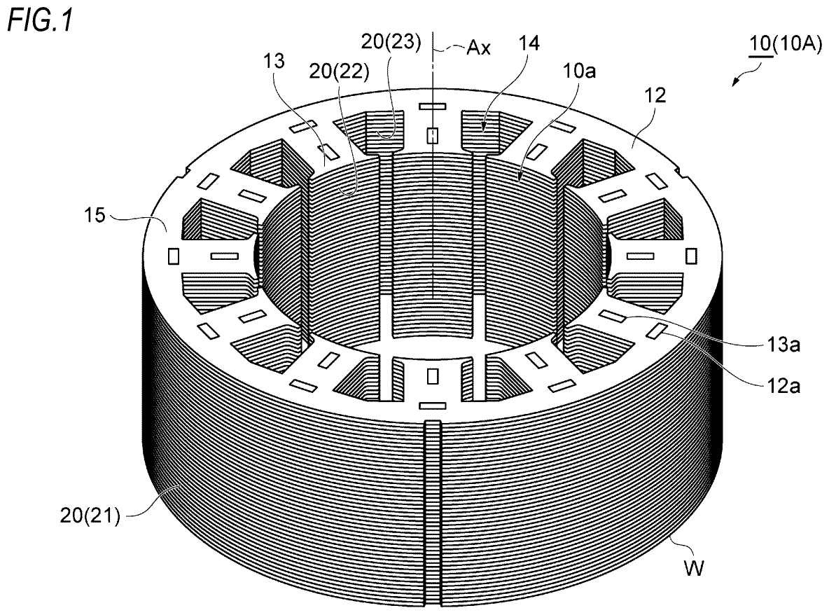

FIG. 1 illustrates an example of the laminated iron core according to each of the embodiments. A laminated iron core 10 is a stator laminated iron core and has a cylindrical shape. In a center portion of the laminated iron core 10, a through hole 10a extending along a center axis Ax is provided. In the through hole 10a, a rotor iron core (rotor) not illustrated in the drawing can be disposed. The laminated iron core 10 and the rotor iron core may configure an electric motor (motor).

The laminated iron core 10 includes a laminate 10A where a plurality of electromagnetic steel sheets W having the same shape are laminated. In a yoke portion 12 and a tooth portion 13, a swaged portion 12a and a swaged portion 13a are provided, respectively. The swaged portion 12a and the swaged portion 13a fasten two electromagnetic steel sheets W adjacent to each other among the plurality of electromagnetic steel sheets W. The laminate 10A includes the annular yoke portion 12 and the tooth portion 13 inside the yoke portion 12.

The yoke portion 12 has an annular shape and extends to surround the center axis Ax. A width, an inner diameter, an outer diameter, and a thickness of the yoke portion 12 in a radial direction may be set to various sizes depending on the use and the performance of the motor. The tooth portion 13 extends along the radial direction of the yoke portion 12 from an inner edge of the yoke portion 12 toward the center axis Ax side. In the laminate 10A, twelve tooth portions 13 are formed to be integrated with the yoke portion 12. The tooth portions 13 are arranged at regular intervals in a circumferential direction of the yoke portion 12. A slot 14 that is a space for disposing a winding (not illustrated) is formed between the tooth portions 13 adjacent to each other.

The laminate 10A includes an outer side surface 21 (outer peripheral surface) and an inner side surface as a side surface 20. The inner side surface includes an inner wall surface 23 that determines the slot 14 and a facing surface 22 that faces the rotor iron core at a tip of the tooth portion 13. The outer side surface 21 and the inner side surface (the facing surface 22, the inner wall surface 23) are covered with the granular oxide containing crystalline magnetite. An end surface 15 and the facing surfaces of the electromagnetic steel sheets W adjacent to each other may be covered with an insulating film containing an organic material and an inorganic material.

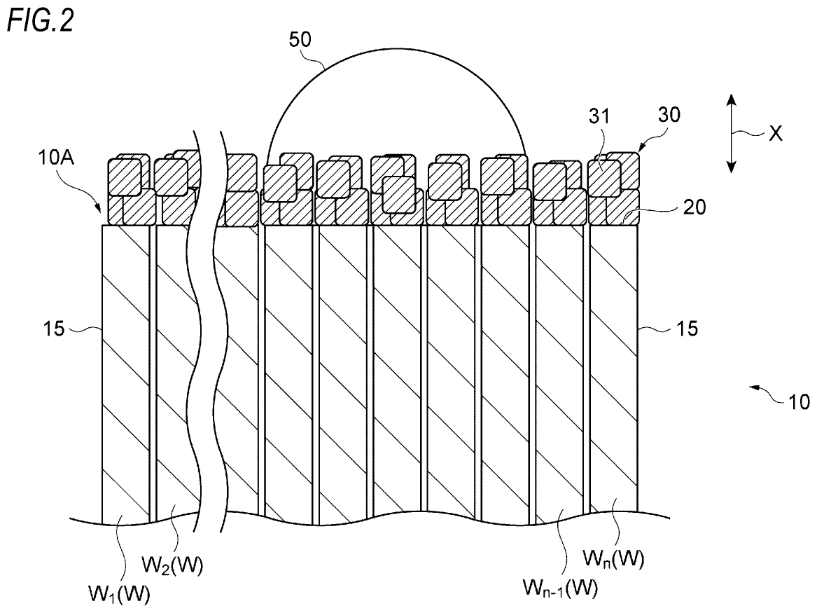

FIG. 2 is a cross-sectional view schematically illustrating a cross-sectional structure of the laminate 10A taken along the laminating direction. As indicated by the direction of the reference numeral, FIG. 2 illustrates a state where the side surface 20 faces upward. The laminate 10A is configured by laminating n sheets of electromagnetic steel sheets W1, W2 . . . , and Wn. The electromagnetic steel sheets W1 and W2 adjacent to each other are fastened . . . by the swaged portions 12a and 13a illustrated in FIG. 1. The side surface 20 of the laminate 10A is covered with an oxide film 30 formed of an oxide containing crystalline magnetite. By including the oxide film 30 having high water repellency, the contact area of water on the side surface 20 can be reduced. The infiltration of water into the oxide film 30 and into a gap between the electromagnetic steel sheets adjacent to each other can be prevented. The oxide film 30 may contain oxide particles 31 having a particle size of 300 nm or more. The oxide particles 31 may be iron oxide particles.

A film thickness of the oxide film 30 is measured along a direction X orthogonal to the laminating direction of the electromagnetic steel sheets W in the SEM photograph showing the cross-section illustrated in FIG. 2. The range of the thickness (film thickness) of the oxide film 30 measured along the direction X is as described above. As illustrated in FIG. 2, the contact angle y can be measured by dropping a water droplet 50 on the oxide particles 31 covering the side surface 20.

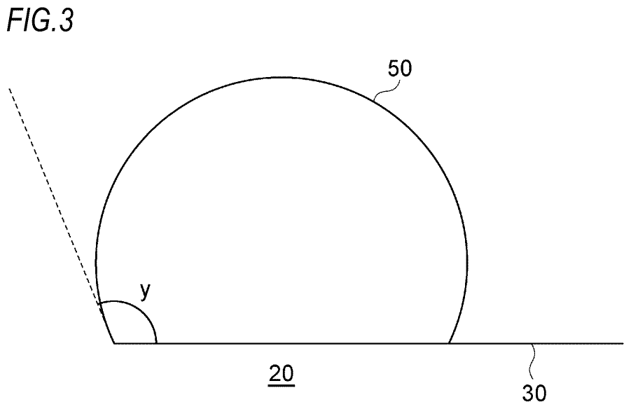

FIG. 3 is a diagram schematically illustrating the contact angle y of the water droplet 50 dropped on the side surface 20 of the laminate. The contact angle y is an angle between a tangent line (broken line in FIG. 3) of the water droplet 50 and the side surface 20 of the laminate in a boundary portion between the side surface 20 of the laminate and the water droplet 50. The range of the contact angle y is as described above. The contact angle y is measured as follows. The temperature of the measurement environment and water is 25° C. 50 μL of water is collected using a syringe. The laminated iron core is fixed such that the side surface 20 faces upward, and water droplets are dropped on the side surface 20 from the syringe. Here, the height of a tip of the syringe from the side surface 20 is 10 mm. A temporal change of the contact angle of the water droplet dropped on the surface of the side surface 20. that is, the oxide film 30 is measured. In the measurement, a microscope (for example, a digital microscope manufactured by Keyence Corporation, VHX-5000 (device name)) can be used.

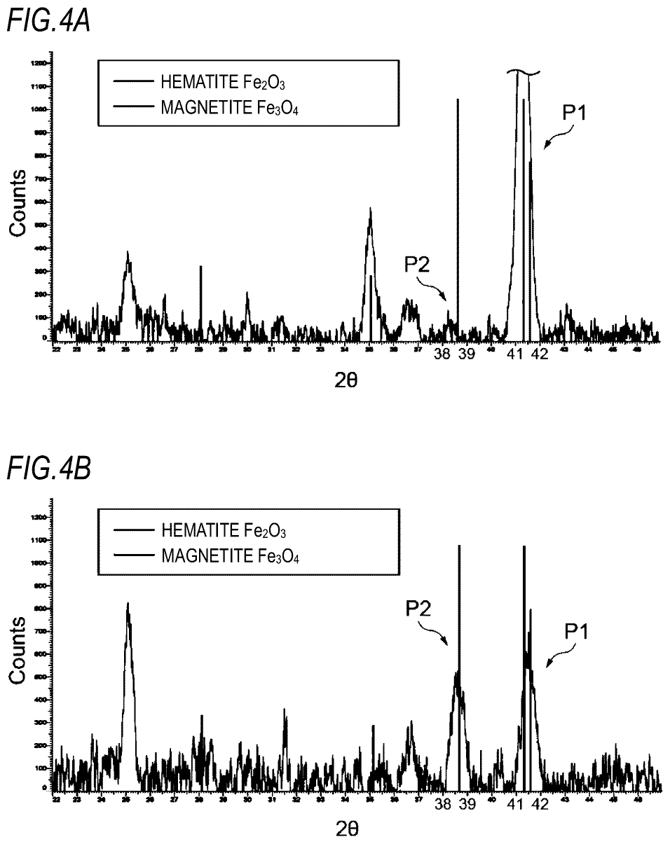

FIGS. 4A and 4B are diagrams illustrating examples of an X-ray diffraction (XRD) measurement result of the side surface 20 covered with the granular oxide. The chart of FIG. 4A illustrates a peak P1 in the range of 2θ of 41° to 42° and a peak P2 in the range of 2θ of 38° to 39°. A height H1 of the peak P1 is obtained as the maximum height when the range of 41° to 42° includes a plurality of peaks. A height H2 of the peak P2 is obtained as the maximum height when the range of 38° to 39° includes a plurality of peaks. When the chart of FIG. 4A and the chart of FIG. 4B are compared, the height H1 of the peak P1 relative to the height H2 of the peak P2 is larger in the chart of FIG. 4A. Accordingly, in the chart, the ratio of crystalline magnetite in the granular oxide covering the side surface is higher. Both of the heights H1 and H2 are heights based on the baseline.

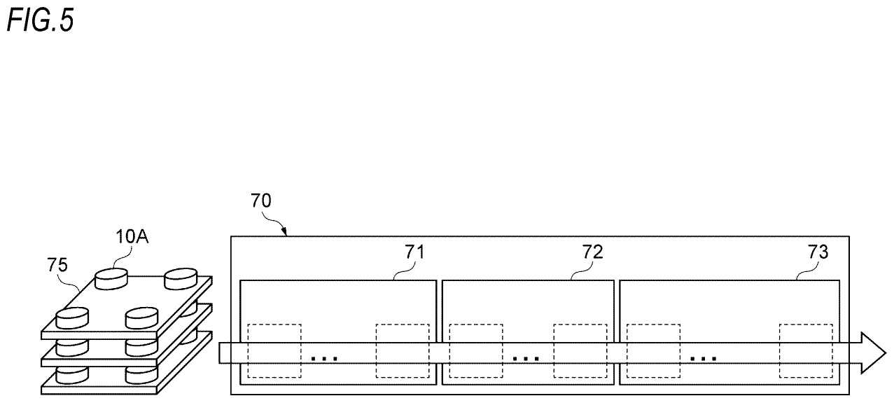

FIG. 5 illustrates an example of a method for manufacturing the laminated iron core 10. In the method for manufacturing the laminated iron core 10, first, the laminate 10A of the electromagnetic steel sheets (iron core pieces) is prepared. The laminate 10A can be manufactured using a well-known method. For example, by stamping base materials of the electromagnetic steel sheets, a plurality of electromagnetic steel sheets (iron core pieces) are obtained. The electromagnetic steel sheets are laminated, and the electromagnetic steel sheets (iron core pieces) adjacent to each other are fastened to each other by swaging or the like.

A plurality of the laminates 10A are arranged on a conveyance jig 75 and conveyed into an annealing facility 70. In the annealing facility 70, a deoiling furnace 71 that performs a burn-off step, an annealing furnace 72 that performs an annealing step, and a bluing furnace 73 that performs the bluing step are arranged in this order from the upstream side to the downstream side. In the burn-off step, for example, the laminate 10A is heated in an inert gas atmosphere such as nitrogen to volatilize stamping oil attached to the electromagnetic steel sheets. In the annealing step, the laminate 10A in the inert gas atmosphere such as nitrogen is heated and annealed. As a result, iron loss is recovered.

In the bluing step, the annealed laminate 10A is heated in an atmosphere containing oxygen and water. Operating conditions (bluing process conditions) of the bluing furnace 73 are as described above. In the bluing step, the oxide particles 31 containing crystalline magnetite are formed on the side surface 20 of the laminate 10A. As such, the side surface 20 is covered with the granular oxide. As a result, the laminated iron core 10 where the contact angle y of the water droplet until 20 minutes elapses after dropping the water droplet is 80° or more can be obtained. In XRD measurement of the side surface 20 covered with the granular oxide, when a height of a peak detected in a range of 2θ of 41° to 42° is represented by H1 and a height of a peak detected in a range of 2θ of 38° to 39° is represented by H2, the laminated iron core 10 where H1/(H1+H2) is 0.8 or more can be obtained. In the laminated iron core 10, the formation of red rust not only on the side surface but also in the laminated iron core 10 can be prevented.

Hereinabove, the embodiments of the present disclosure have been described, but the present disclosure is not limited to the embodiments. For example, the shape and the structure of the laminated iron core are not limited to those illustrated in FIG. 1. That is, the structures and the shapes of the laminate 10A, the yoke portion 12, and the tooth portion 13 are examples. The laminate may be formed by connecting members each of which includes one yoke and one tooth along the circumferential direction. Only one of the yoke portion 12 and the tooth portion 13 may include the swaged portion.

### EXAMPLES

The content of the present disclosure will be described in detail with reference to Examples and Comparative Examples, but the present disclosure is not limited to the following Examples.

### [Manufacturing of Laminated Iron Core]

### Example 1

A laminate where about 50 sheets of electromagnetic steel sheets (stamped steel sheets, thickness: 0.25 mm) were laminated was prepared. Electromagnetic steel sheets vertically adjacent to each other in the laminate were fastened to each other by swaging. The laminate was introduced into the annealing facility illustrated in FIG. 5, and the burn-off step, the annealing step, and the bluing step were sequentially performed. In the bluing step, water vapor and air were introduced together with inert gas such that a predetermined oxygen concentration and a predetermined dew point were obtained. The bluing step was performed while monitoring the heating temperature, the oxygen concentration, and the dew point in the bluing furnace using a thermometer, an oxygen meter, and a dew-point meter, respectively. Process conditions (the heating temperature, the heating time, and the oxygen concentration and the dew point in the atmosphere) in the bluing step were as shown in Table 2. As such, a stator laminated iron core was manufactured.

### Examples 2 to 4

A stator laminated iron core was manufactured according to the same procedure as that of Example 1, except that the heating time was changed as shown in Table 2 in the bluing step.

### Example 5

A stator laminated iron core was manufactured according to the same procedure as that of Example 2, except that the heating temperature was changed as shown in Table 3 in the bluing step.

### Example 6

A stator laminated iron core was manufactured according to the same procedure as that of Example 3, except that the heating temperature was changed as shown in Table 3 in the bluing step.

### Comparative Example 1

A stator laminated iron core was manufactured according to the same procedure as that of Example 5, except that the heating time and the oxygen concentration were changed as shown in Table 3 in the bluing step.

### Comparative Example 2

A stator laminated iron core was manufactured according to the same procedure as that of Example 1, except that the bluing step was not performed.

### Example 7

A stator laminated iron core was manufactured according to the same procedure as that of Example 1, except that the dew point was changed as shown in Table 4 in the bluing step. The dew point was adjusted by changing the amount of the water vapor introduced into the bluing furnace.

### Example 8

A stator laminated iron core was manufactured according to the same procedure as that of Example 2, except that the dew point was changed as shown in Table 4 in the bluing step. The dew point was adjusted by changing the amount of the water vapor introduced into the bluing furnace.

### Comparative Example 3

A stator laminated iron core was manufactured according to the same procedure as that of Example 1, except that heating in the annealing facility was not performed.

[Evaluation of Laminated Iron Core]

### <XRD Measurement>

XRD measurement was performed on the side surface of the laminated iron core manufactured in each of Examples and Comparative Examples. The XRD measurement was performed using an X-ray diffractometer (for example, D8 DISCOVER (device name) manufactured by Bruker Corporation) using a CuKα ray. Measurement conditions were as follows.

Measurement range (2θ): 22° to 47°
Measurement time: 600 seconds
Tube: Co tube
Measurement diameter: ϕ0.5 mm
The height H1 of the peak P1 detected in the range of 2θ of 41° to 42° and the height H2 of the peak P2 detected in the range of 2θ of 38° to 39° were respectively obtained. When the peak P2 was covered in noise in the vicinity of the baseline and thus was not able to be detected, H2=0 was set. The value of H1/(H1+H2) was calculated from the obtained heights H1 and H2. The results were as shown in Table 1.

As shown in Table 1, in all of Examples 1 to 8, the formation of the oxide containing crystalline magnetite on the side surface of the laminate was able to be verified. On the other hand, in Comparative Example 1 where the oxygen concentration in the atmosphere was high, not only the formation of crystalline magnetite but also the formation of crystalline hematite were verified. In Comparative Example 2, clear peaks showing the presence of crystalline magnetite and crystalline hematite were not detected, and both H1 and H2 was 0. It was considered that, in Comparative Example 3 where heating in the annealing facility was not performed, crystalline magnetite and crystalline hematite were not present as in Comparative Example 2.

TABLE 1

| | H1/(H1 + H2) |
|---|---|
| Example 1 | 1.0 |
| Example 2 | 1.0 |
| Example 3 | 1.0 |
| Example 4 | 1.0 |
| Example 5 | 1.0 |
| Example 6 | 1.0 |
| Example 7 | 1.0 |
| Example 8 | 1.0 |
| Comparative Example 1 | 0.7 |

### <Measurement of Contact Angle>

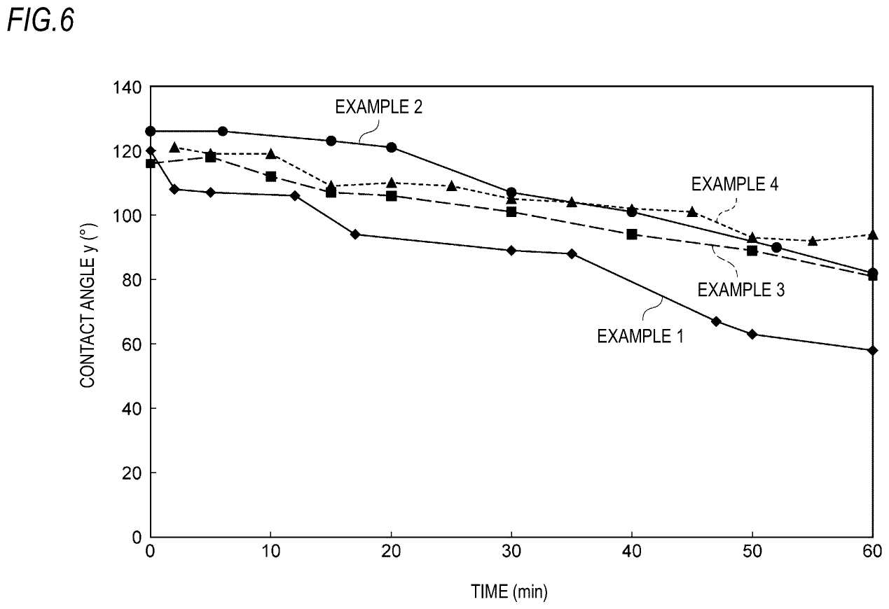

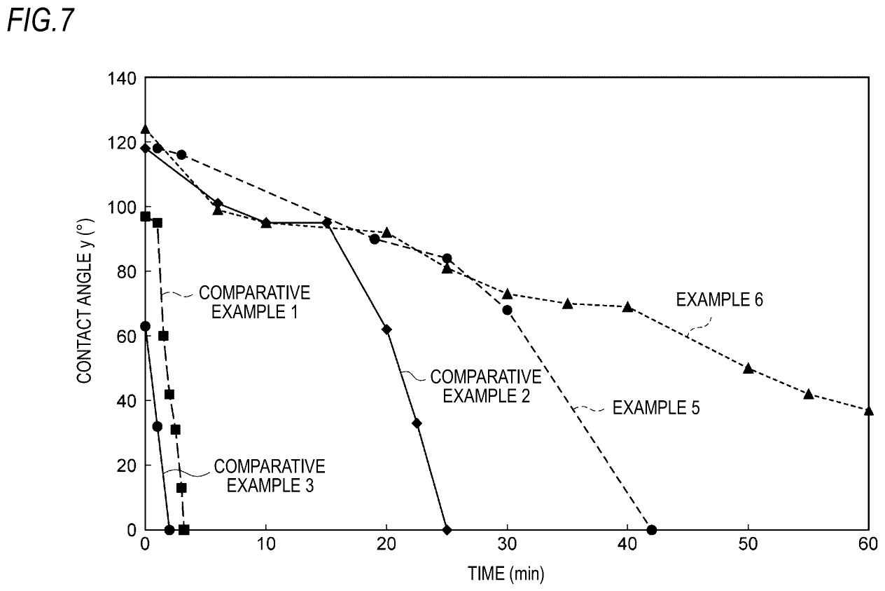

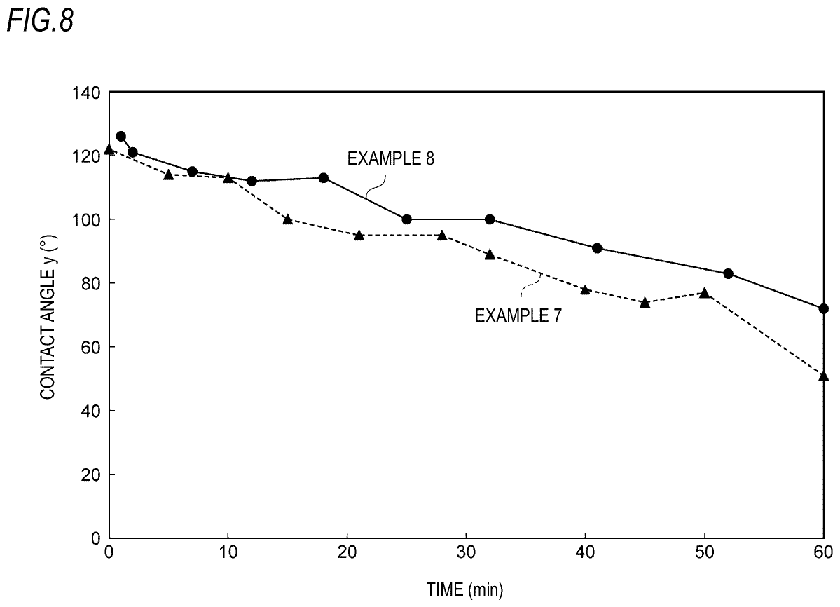

The laminated iron core manufactured in each of Examples and Comparative Examples was fixed using a clamp such that a part of the side surface of the laminate faced upward. In an environment of 25° C., 50 μl of water (25° C.) was dropped on a portion of the side surface of the laminate facing upward using a syringe. Here, the height of a tip of the syringe from the side surface 20 was 10 mm. A temporal change of the contact angle y (FIG. 3) of the water droplet dropped on the side surface was measured. In the measurement, a microscope (for example, a digital microscope manufactured by Keyence Corporation, VHX-5000 (device name)) was used. Data regarding the elapsed time after dropping the water droplet and the contact angle were as shown in Tables 2, 3, and 4. FIGS. 6, 7, and 8 illustrate relationships between the elapsed time and the contact angle y.

As shown in Tables 2, 3, and 4 and FIGS. 6, 7, and 8, on the side surface of the laminate in the laminated iron core according to each of Examples, the contact angle y was larger and the water repellency was higher than those of each of Comparative Examples. As the heating temperature in the bluing step increased, the contact angle y tended to increase and the water repellency tended to become higher. On the other hand, in Comparative Example 1 where the oxygen concentration was high, the contact angle y was smaller and the water repellency was lower than those of each of Examples. As such, examples of a cause for the low water repellency include the formation of hematite.

### <Rust Acceleration Test>

The stator laminated iron core according to each of Examples and Comparative Examples was cut along the laminating direction to obtain a sample. The sample was put into a thermo-hygrostat (temperature: 50° C., humidity: 90% RH). The temperature of the sample before putting the sample into the thermo-hygrostat was 25° C. Therefore, when the sample was put into the thermo-hygrostat, dew condensation occurred, and thus rust was likely to be formed in the sample. When 24 hours elapsed after putting the sample into the thermo-hygrostat, the sample was taken out from the thermo-hygrostat, and an appearance inspection of the side surface of the laminate was performed.

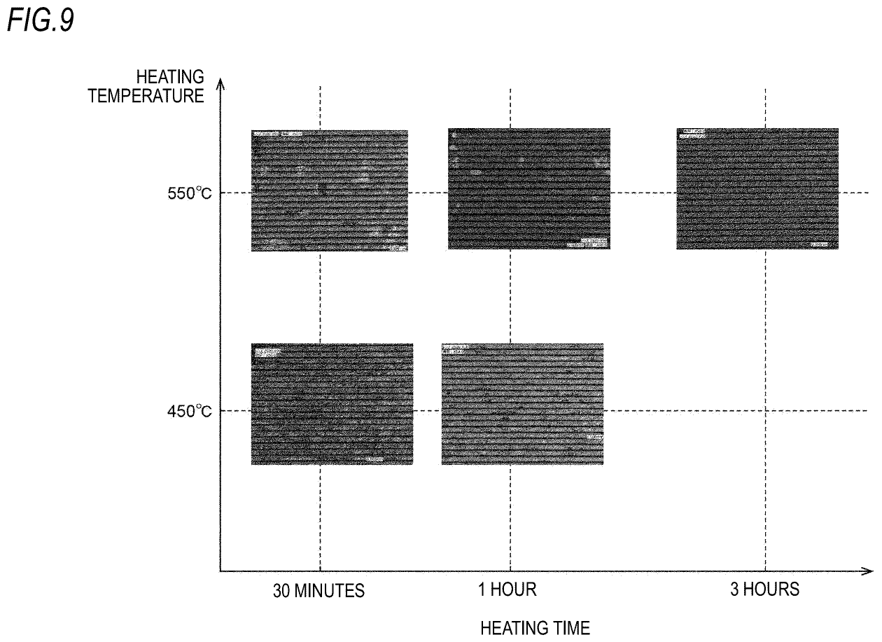

FIG. 9 illustrate photographs of the side surfaces of Examples 2 to 6 by the microscope. As illustrated in FIG. 9, it was verified that, at 550° C., the formation of red rust on the side surface was able to be further reduced as compared to 450° C. It was verified that, as the heating time increased, the formation area of red rust on the side surface was able to be further reduced.

In the sample (laminate) according to each of Examples and Comparative Examples, the amount of red rust formed on the side surface of the sample and in the sample was evaluated based on the following criteria. The evaluation of the amount of red rust formed in the laminate was performed on surfaces (main surfaces) of samples obtained by disassembling the laminate to obtain one electromagnetic steel sheet in the laminate.
A: red rust was almost not formed
B: the formation area of red rust was less than that of Example 2, and a smaller amount of red rust was formed
C: the formation area of red rust was the same as that of Example 2, and the formation of red rust and the area thereof were clearly less than those of Comparative Example 2
D: the formation area of red rust was the more than that of Example 2 and was less than that of Comparative Example 2
E: the formation area of red rust was the same as that of Comparative Example 2

As shown in Tables 2, 3, and 4, the formation area of red rust on the side surface of the laminate according to each of Examples 1 to 8 were less than those of Comparative Examples 2 and 3. In the laminates according to Examples 1 to 8, that is, on the main surfaces of the electromagnetic steel sheets, the formation area of red rust was also less than those of Comparative Examples 2 and 3 as in the side surface. In the laminate according to Comparative Example 1, red rust was almost not formed on the side surface, but a larger area of red rust was formed in the laminate. The reason is presumed to be that the oxide covering the side surface contained hematite and hematite had low water repellency such that a large amount of water infiltrated into the laminated iron core.

As such, it was verified that, in Examples 1 to 8, the formation of red rust in the laminate of the laminated iron core was able to be further prevented than that of Comparative Examples 1 to 3. As shown in Table 4, it was verified that, even when the dew point was high, the formation of red rust on the side surface and in the laminate was able to be prevented. When Examples 1 and 7 were compared with Examples 2 and 8 having the same conditions except for the dew point, the contact angles y were not much different from each other.

### <SEM Observation of Side Surface and Cross-Section>

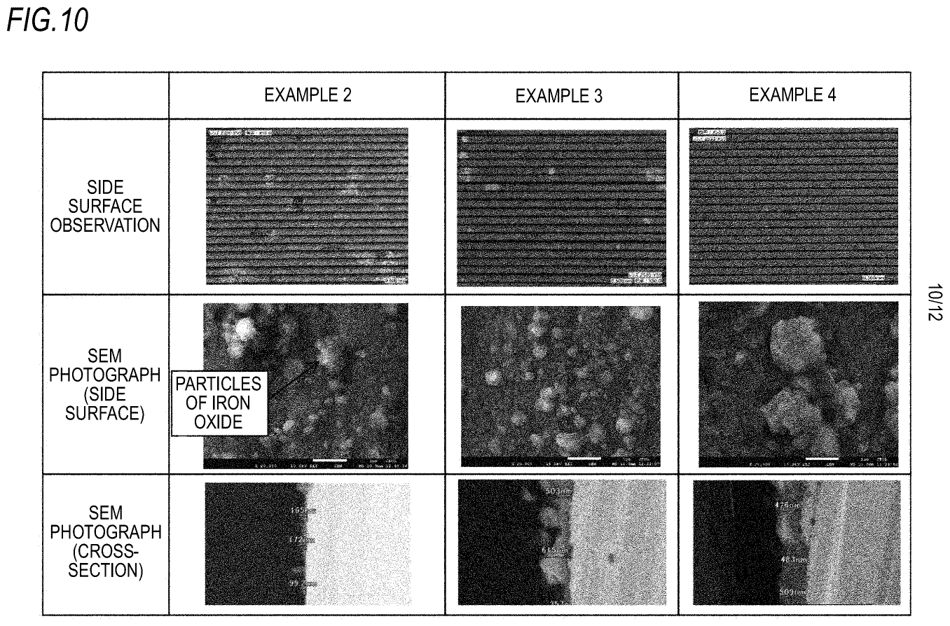

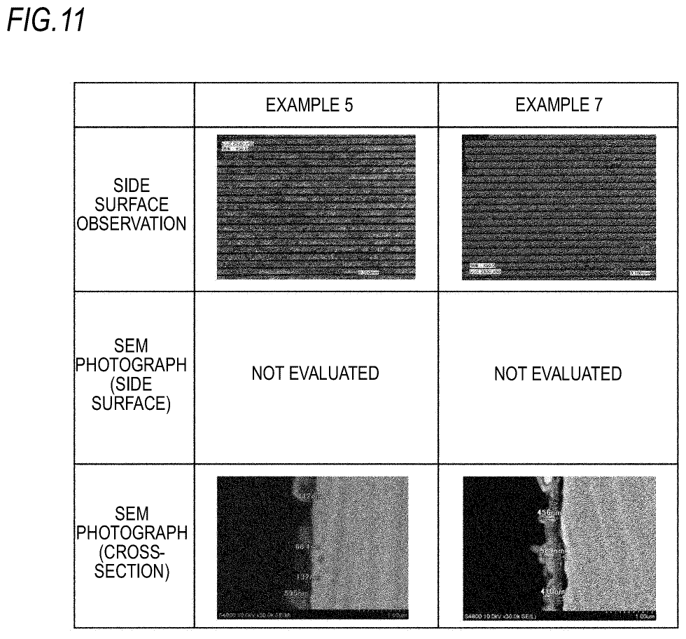

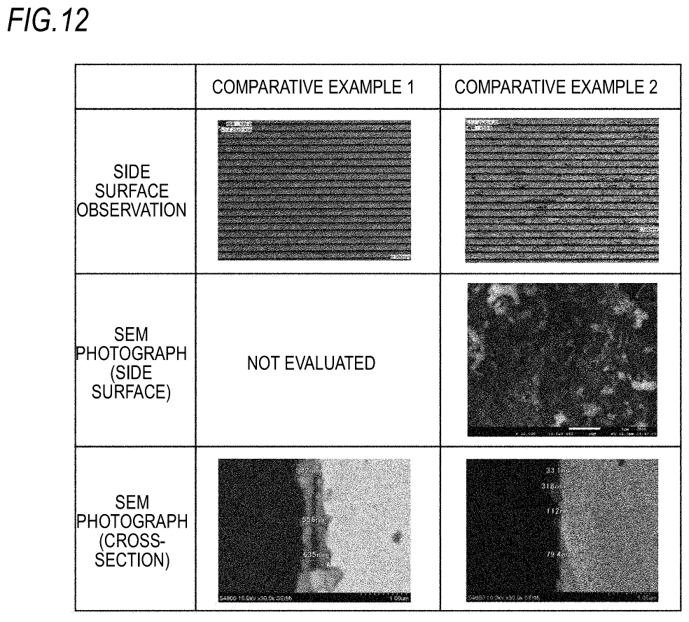

The side surface and the cross-section of the laminate in the stator laminated iron core according to each of Examples 1 to 8 and Comparative Examples 1 and 2 were observed with the SEM. In some of Examples and Comparative Examples, only the cross-section was observed with the SEM. The observation of the cross-section was performed on an outer peripheral surface of a sample obtained by cutting the laminate along the laminating direction. FIG. 10 illustrate SEM photographs (20000-fold) of the side surfaces of Examples 2, 3, and 4 and SEM photographs (30000-fold) of the cross-sections thereof. FIGS. 11 and 12 illustrate SEM photographs of Examples 5 and 7, and FIG. 12 illustrates SEM photographs of Comparative Examples 1 and 2. FIGS. 10, 11, and 12 also illustrate photographs of the side surfaces obtained by the microscope.

The particle sizes of oxide particles attached to the side surface were measured based on the SEM photograph of the side surface according to each of Examples and Comparative Examples. The particle sizes of the largest oxide particles in the obtained SEM photographs were as shown in Tables 2, 3, and 4. As the heating temperature increased and as the heating time increased, the particle sizes of the particles tended to increase. In each of the tables, “-” represents “Not Measured”.

Whether the oxide was formed in a film shape on the side surface of the laminate of the laminated iron core was determined based on the SEM photograph of the cross-section of the side surface in each of Examples and Comparative Examples. When the oxide film was formed in a film shape, the thickness (film thickness) was measured based on the SEM photograph. Regarding Examples and Comparative Examples where the film thickness was measured, the measurement results were shown in Tables 2, 3, and 4. The fields of Examples where the film thickness was not measured were blank. When the oxide particles were scattered on the side surface and the oxide was not formed in a film shape, the oxide film was evaluated as “Not Formed”.

5 The results were as shown in the lower sections of Tables 2, 3, and 4. As shown in Tables 2, 3, and 4, in Examples 1 to 8, the entire side surface of the laminate was covered with the oxide film. The evaluation results of “Inside” of the rust acceleration test were “A”, “B”, or “C”, and the formation of red rust on the main surfaces of the electromagnetic steel sheets configuring the laminated iron core was sufficiently prevented. This implies that the oxide film containing magnetite effectively acted to prevent the formation of red rust in the laminate. The entire side surface of the laminate according to Comparative Example 1 was covered with the oxide film too, but there were portions where cavities were formed in the oxide film. The evaluation result of “Inside” of the rust acceleration test was “D”.

TABLE 2

| Example 1 | | Example 2 | | Example 3 | | Example 4 | |
|---|---|---|---|---|---|---|---|
| Heating Temperature: | | Heating Temperature: | | Heating Temperature: | | Heating Temperature: | |
| 550° C. | | 550° C. | | 550° C. | | 550° C. | |
| Heating Time: | | Heating Time: | | Heating Time: | | Heating Time: | |
| 10 Minutes | | 30 Minutes | | 1 Hour | | 3 Hours | |
| Oxygen Concentration: | | Oxygen Concentration: | | Oxygen Concentration: | | Oxygen Concentration: | |
| 15 ppm | | 15 ppm | | 15 ppm | | 15 ppm | |
| Dew Point: 30° C. | | Dew Point: 30° C. | | Dew Point: 30° C. | | Dew Point: 30° C. | |
| Time | Contact | Time | Contact | Time | Contact | Time | Contact |
| (min) | Angle (°) | (min) | Angle (°) | (min) | Angle (°) | (min) | Angle (°) |
| 0 | 120 | 0 | 126 | 0 | 116 | 2 | 121 |
| 2 | 108 | 6 | 126 | 5 | 118 | 5 | 119 |
| 5 | 107 | 15 | 123 | 10 | 112 | 10 | 119 |
| 12 | 106 | 20 | 121 | 15 | 107 | 15 | 109 |
| 17 | 94 | 30 | 107 | 20 | 106 | 20 | 110 |
| 30 | 89 | 40 | 101 | 30 | 101 | 25 | 109 |
| 35 | 88 | 52 | 90 | 40 | 94 | 30 | 105 |
| 47 | 67 | 60 | 82 | 50 | 89 | 35 | 104 |
| 50 | 63 | 70 | 73 | 60 | 81 | 40 | 102 |
| 60 | 58 | 80 | 51 | 70 | 74 | 45 | 101 |
| 72 | 42 | 90 | 36 | — | — | 50 | 93 |
| 75 | 18 | | | | | 55 | 92 |
| | | | | | | 60 | 94 |

Rust Acceleration Test

| | | | |
|---|---|---|---|
| Side Surface: C | Side Surface: C | Side Surface: B | Side Surface: A |
| Inside: C | Inside: C | Inside: B | Inside: A |

SEM Observation Results of Side Surface and Cross-section

| | | | |
|---|---|---|---|
| Particle Size: — | Particle Size: 0.7 μm | Particle Size: 0.8 μm | Particle Size: 1.5 μm |
| Oxide Film: Formed | Oxide Film: Formed | Oxide Film: Formed | Oxide Film: Formed |
| | | Film Thickness: 0.2 to | Film Thickness: 0.4 to |
| | | 0.6 μm | 0.5 μm |

TABLE 3

| | | Comparative | Comparative |
|---|---|---|---|
| Example 5 | Example 6 | Example 1 | Example 2 |
| Heating Temperature: | Heating Temperature: | Heating Temperature: | No Bluing Step |
| 450° C. | 450° C. | 450° C. | |
| Heating Time: | Heating Time: | Heating Time: | |
| 30 Minutes | 1 Hour | 3 Hours | |
| Oxygen Concentration: | Oxygen Concentration: | Oxygen Concentration: | |
| 15 ppm | 15 ppm | 20000 ppm | |
| Dew Point: 30° C. | Dew Point: 30° C. | Dew Point: 30° C. | |

| Time | Contact | Time | Contact | Time | Contact | Time | Contact |
|---|---|---|---|---|---|---|---|
| (min) | Angle (°) | (min) | Angle (°) | (min) | Angle (°) | (min) | Angle (°) |
| 1 | 118 | 0 | 124 | 0 | 97 | 0 | 118 |
| 3 | 116 | 6 | 99 | 1 | 95 | 6 | 101 |
| 19 | 90 | 10 | 95 | 1.5 | 60 | 10 | 95 |
| 25 | 84 | 20 | 92 | 2 | 42 | 15 | 95 |
| 30 | 68 | 25 | 81 | 2.5 | 31 | 20 | 62 |
| 42 | 0 | 30 | 73 | 3 | 13 | 22.5 | 33 |
| — | — | 35 | 70 | 3.2 | 0 | 25 | 0 |
| — | — | 40 | 69 | — | — | — | — |
| — | — | 50 | 50 | — | — | — | — |
| — | — | 55 | 42 | — | — | — | — |
| — | — | 60 | 37 | — | — | — | — |

Rust Acceleration Test

| | | | |
|---|---|---|---|
| Side Surface: D | Side Surface: D | Side Surface: A | Side Surface: E |
| Inside: C | Inside: C | Inside: D | Inside: E |

SEM Observation Results of Side Surface and Cross-section

| | | | |
|---|---|---|---|
| Particle Size: — | Particle Size: 0.6 μm | Particle Size: — | Particle Size: |
| | | | Immeasurable |
| Oxide Film: Formed | Oxide Film: Formed | Oxide Film: Formed | Oxide Film: Not |
| | | Film Thickness: 0.5 to | Formed |
| | | 0.7 μm | |

TABLE 4

| | | |
|---|---|---|
| Example 7 | Example 8 | |
| Heating Temperature: 550° C. | Heating Temperature: 550° C. | |
| Heating Time: 10 Minutes | Heating Time: 30 Minutes | Comparative |
| Oxygen Concentration: 15 ppm | Oxygen Concentration: 15 ppm | Example 3 |
| Dew Point: 60° C. | Dew Point: 60° C. | No Heating |

| | Contact Angle | | Contact Angle | Time | Contact Angle |
|---|---|---|---|---|---|
| Time (min) | (°) | Time (min) | (°) | (min) | (°) |
| 0 | 122 | 1 | 126 | 0 | 63 |
| 5 | 114 | 2 | 121 | 1 | 32 |
| 10 | 113 | 7 | 115 | 2 | 0 |
| 15 | 100 | 12 | 112 | — | — |
| 21 | 95 | 18 | 113 | — | — |
| 28 | 95 | 25 | 100 | — | — |
| 32 | 89 | 32 | 100 | — | — |
| 40 | 78 | 41 | 91 | — | — |
| 45 | 74 | 52 | 83 | — | — |
| 50 | 77 | 60 | 72 | — | — |
| 60 | 51 | 70 | 65 | — | — |

Rust Acceleration Test

| | | |
|---|---|---|
| Side Surface: B | Side Surface: B | Side Surface: E |
| Inside: C | Inside: C | Inside: E |

SEM Observation Results of Side Surface and Cross-section

| | | |
|---|---|---|
| Particle Size: — | Particle Size: — | Particle Size: — |
| Oxide Film: Formed | Oxide Film: Formed | Oxide Film: |
| Film Thickness: 0.2 to 0.6 μm | Film Thickness: 0.3 to 0.6 μm | Not Formed |

### INDUSTRIAL APPLICABILITY

Provided are a laminated iron core where the formation of red rust can be prevented and a method for manufacturing the same.

The present application is based on Japanese Patent Application No. 2021-173640 filed on Oct. 25, 2021, the entire content of which is incorporated herein by reference.

### REFERENCE SIGNS LIST

10: laminated iron core
10A: laminate
10a: through hole
12: yoke portion
13: tooth portion
12a, 13a: swaged portion
14: slot
15: end surface
20: side surface
21: outer side surface
22: facing surface
23: inner wall surface
30: oxide film
31: oxide particle
50: water droplet
70: annealing facility
71: deoiling furnace
72: annealing furnace
73: bluing furnace
75: conveyance jig
Ax: center axis
W: electromagnetic steel sheet

1. A laminated iron core comprising:
a laminate of electromagnetic steel sheets; and
a granular oxide that contains magnetite and covers a side surface of the laminate, wherein
a contact angle of a water droplet until 20 minutes elapses after dropping the water droplet on the side surface covered with the granular oxide is 80° or more.

2. The laminated iron core according to claim 1, wherein
at least a part of the magnetite is crystalline.

3. A laminated iron core comprising:
a laminate of electromagnetic steel sheets; and
a granular oxide that contains crystalline magnetite and covers a side surface of the laminate, wherein
when heights of peaks detected in ranges of 2θ of 41° to 42° and 38° to 39° in XRD measurement of the side surface covered with the granular oxide are represented by H1 and H2, respectively, H1/(H1+H2) is 0.8 or more.

4. The laminated iron core according to claim 1, wherein
the granular oxide contains particles having a particle size of 300 nm or more.

5. The laminated iron core according to claim 1, wherein
the side surface of the laminate is covered with an oxide film containing the granular oxide.

6. The laminated iron core according to claim 1, wherein
the granular oxide does not contain crystalline hematite.

7. The laminated iron core according to claim 1, wherein
the electromagnetic steel sheets include stamped steel sheets, and
the stamped steel sheets adjacent to each other in a laminating direction are fastened to each other by swaging.

8. A method for manufacturing a laminated iron core, the method comprising oxidizing a side surface of a laminate of electromagnetic steel sheets by heating the laminate while introducing water vapor in a bluing furnace having an atmosphere containing oxygen, wherein
in the bluing furnace, a granular oxide containing magnetite is formed on the side surface of the laminate by heating the laminate under conditions including an oxygen concentration of less than 500 ppm and a heating temperature of 400° C. to 600° C.

9. The method for manufacturing a laminated iron core according to claim 8, wherein
a dew point of the bluing furnace is 10° C. or higher.
